(19) United States
(12) Patent Application Publication
(10) Pub. No.: US 2024/0365911 A1
(43) Pub. Date: Nov. 7, 2024

(54) MULTI-POSITION HELMET MOUNT PIVOT HINGE AND HELMET MOUNT APPARATUS EMPLOYING SAME

(71) Applicant: WILCOX INDUSTRIES CORP., Newington, NH (US)

(72) Inventors: James W. Teetzel, Portsmouth, NH (US); Gary M. Lemire, Lee, NH (US)

(21) Appl. No.: 18/650,840

(22) Filed: Apr. 30, 2024

Related U.S. Application Data
(60) Provisional application No. 63/463,171, filed on May 1, 2023.

(51) Int. Cl. A42B 3/32; A42B 3/04

(52) U.S. Cl. CPC A42B 3/324; A42B 3/042

(57) ABSTRACT

A pivot assembly for pivoting a viewing device in relation to a helmet includes a connection plate configured to be coupled to a helmet interface assembly. A hinge barrel is pivotable about a pivot axis in relation to the connection plate among (a) a deployed position in which the hinge barrel is held relative to the connection plate in positive, locking retention; 5 (b) a stowed position in which the hinge barrel is held relative to the connection plate in positive, locking retention; and (c) an intermediate position between the deployed and stowed positions, wherein the hinge barrel is held relative to the connection plate by a threshold retentive force and wherein displacement of the hinge barrel from the intermediate position 10 relative to the connection plate requires application of an actuating force which exceeds the threshold retentive force. In a further aspect, a helmet mount apparatus is provided.

### CROSS REFERENCE TO RELATED APPLICATION

This application claims the priority benefit of U.S. provisional application No. 63/463,171 filed May 1, 2023. The aforementioned application is incorporated herein by reference in its entirety.

### BACKGROUND

The present invention relates to pivoting helmet mounts and, in particular, to an improved pivot hinge for a helmet mount apparatus and a helmet mount apparatus employing same.

Helmets, such as military and law-enforcement helmets, with front shrouds for attaching helmet mount assemblies are known, such as disclosed in commonly owned U.S. Pat. No. 8,739,313. These helmet mount assemblies are configured to support a night vision device, optical device, or other viewing device in front of one or both eyes of a user. Such helmet mount assemblies commonly include a pivot mechanism to allow the viewing device to be pivoted between a deployed position in front of the user's eyes when the viewing device is in use and a stowed position above the user's line of sight when the viewing device is not deployed, e.g., to allow the user to perform a different task or respond to a changing situation.

One type of pivot assembly or hinge utilizes a locking mechanism for holding the pivot assembly in the selected one of deployed and stowed positions. Such locking pivot assemblies typically utilize a mechanical actuator, such as a push button, and are advantageous in that they provide positive, locking retention of the pivot assembly in the selected position.

Another type of pivot assembly utilizes a force-to-overcome mechanism for securing the pivot assembly in a selected one of the deployed and stowed positions. Such pivot assemblies create a certain amount of resistance in the stowed and deployed positions and require the user to manually apply a certain amount of force to overcome the resistance in order to move the viewing device from the deployed position to the stowed position and vice versa. Such systems allow pivoting movement between the deployed and stowed positions in a rapid manner since manipulation of an unlocking actuator is not necessary. However, such pivot mechanisms do not have a true locking mechanism that will hold the viewing device securely in place in the deployed and stowed positions and may allow the pivot assembly to become dislodged and shift its position in certain scenarios, such as during a hard parachute landing, collisions or impacts to the helmet, helmet mount apparatus, viewing device, or user, contact with objects such as low branches or door frames, rapid movement such as during evasive maneuvers, and the like.

The present disclosure contemplates a new and improved pivot assembly for a helmet mount apparatus and a helmet mount apparatus employing same which overcome the above-referenced problems and others.

### SUMMARY

The present inventors have recognized that it would be desirable to provide a pivot hinge or subsystem for a helmet mount apparatus and a helmet mount apparatus employing same with an improved pivot mechanism for attaching a viewing device that provides positive, locking retention in the stowed and deployed positions, while also providing a third, partially stowed position which is intermediate the stowed and deployed positions. The pivot assembly includes a detent mechanism configured to hold the viewing device in the intermediate (i.e., partially flipped up) position. The detent mechanism functions as a force to overcome type retention system which secures the viewing device in the intermediate position until the user pulls down to re-deploy the viewing device or pushes up to stow the viewing device, without the need to press the push button actuator.

In one aspect, a pivot assembly is provided for pivoting a viewing device in relation to a helmet wherein the pivot assembly includes a connection plate configured to be coupled to a helmet interface assembly. A hinge barrel is pivotable about a pivot axis in relation to the connection plate among (a) a deployed position in which the hinge barrel is held relative to the connection plate in positive, locking retention; (b) a stowed position in which the hinge barrel is held relative to the connection plate in positive, locking retention; and (c) an intermediate position between the deployed and stowed positions, wherein the hinge barrel is held relative to the connection plate by a threshold retentive force and wherein displacement of the hinge barrel from the intermediate position relative to the connection plate requires application of an actuating force which exceeds the threshold retentive force.

In a more limited aspect, the pivot assembly includes first and second hinge knuckles disposed on opposing transverse sides of the connection plate, the hinge barrel disposed between the first and second hinge knuckles and defining a cylindrical bore along the pivot axis. A first aperture is formed in a sidewall of the hinge barrel which provides access to the cylindrical bore. A pivot arm is coupled to the hinge barrel and is configured to rotate with the hinge barrel about the pivot axis. A detent bore extends radially through the pivot arm and communicating with the cylindrical bore. A bushing includes a cylindrical body and an axially-extending bore and is disposed within the cylindrical bore of the hinge barrel. The bushing includes a recess formed on the cylindrical body and a second aperture extends radially from an outer surface of the cylindrical body to the axially-extending bore, wherein the second aperture is elongated in the axial direction and has a preselected axial extent. A detent assembly received within the detent bore, the detent assembly having a resilient protrusion, the resilient protrusion complementary with the recess. A pivot rod is telescopically received within the axially-extending bore of the bushing. A biasing spring is disposed within the axially-extending bore and is configured to urge the pivot rod in an outward direction along the pivot axis. A positioning pin is secured to said pivot rod and passes through the second aperture and extends at least partially into the first aperture. The second aperture is configured to limit telescoping movement between the pivot rod and the bushing to said axial extent. The first aperture is configured to constrain a range of rotational movement of the hinge barrel in relation to the bushing when the hinge barrel is pivoted between the deployed, intermediate, and stowed positions.

In another more limited aspect, the detent assembly comprises a detent member received within the detent bore, the detent member having a tongue disposed on an upper surface and a threaded set screw that engages internal threads within the detent bore. At least one detent spring member is captured within the detent bore between the detent member and the threaded set screw, such that the at least one spring member urges the detent member away from the threaded set screw and toward the bushing.

In another more limited aspect, the pivot rod comprises a shaft portion received within the axially-extending bore and a manually actuatable push button.

In another more limited aspect, the first aperture comprises a first segment which extends parallel to the pivot axis and having a first end and a second end opposite the first end and a second segment which extends parallel to the pivot axis and having a first end and a second end opposite the first end, the second segment axially aligned with the first segment and angularly spaced apart from the first segment. A third segment extends transversely with respect to the pivot axis, the third segment intersecting with the second end of the first segment and the second end of the second segment.

In another more limited aspect, the biasing spring is configured to urge the positioning pin toward the first end of the first segment when the hinge barrel is pivoted to the deployed position and the biasing spring is configured to urge the positioning pin toward the first end of the second segment when the hinge barrel is pivoted to the stowed position.

In another more limited aspect, the resilient protrusion is configured to engage the recess when the hinge barrel is manually pivoted to the intermediate position, wherein the positioning pin is disposed within the third segment at a position intermediate the second end of the first segment and the second end of the second segment.

In another more limited aspect, the first segment is tapered to narrow toward the first end of the first segment and the second segment is tapered to narrow toward the first end of the second segment.

In another more limited aspect, the pivot assembly further includes a carriage assembly coupled to the hinge barrel, the carriage assembly configured to interface with the viewing device.

In another more limited aspect, the carriage assembly comprises one or more rail members secured to the hinge barrel and a sliding carriage configured to be selectively positioned on the one or more rail members for adjusting a distance between the viewing device and an eye of a user.

In another more limited aspect, the pivot assembly further includes a helmet interface assembly coupled to the connection plate, the helmet interface assembly configured to secure the pivot assembly to a helmet.

In another more limited aspect, the helmet interface assembly includes a front interface plate disposed coupled to the connection plate, the front interface plate includes vertical adjustment rails defining a channel and a cam lock member disposed on a rear, helmet-facing side of the connection plate, the cam lock member received within the channel. A vertical adjustment lever is disposed on a forward facing side of the connection plate and is secured to the cam lock member and is rotatable between a locked position and an unlocked position. The cam lock member is configured to slide within the channel when the lever is in the unlocked position and to be held in place within the channel when the lever is in the locked position.

In another more limited aspect, the helmet interface assembly includes a breakaway mechanism configurable between a non-breakaway configuration and a breakaway configuration, wherein the helmet interface assembly is configured to securely lock to a mounting fixture disposed on the helmet when the breakaway mechanism is in the non-breakaway configuration and wherein the helmet interface assembly is configured to separate from the mounting fixture upon application of a predetermined force when the breakaway mechanism is in the breakaway configuration.

In another more limited aspect, the mounting fixture is selected from the group consisting of a three-hole shroud and a one hole shroud.

In another more limited aspect, the pivot assembly further includes a tilt adjustment assembly for adjusting a tilt position of the viewing device relative to an eye of a user.

In a further aspect, a helmet mount apparatus for a viewing device includes a helmet interface assembly configured to engage with a helmet, a pivot assembly of coupled to the helmet interface assembly, and a carriage assembly coupled to the pivot assembly, the carriage assembly configured to engage with the viewing device. The pivot assembly includes a connection plate configured to be coupled to a helmet interface assembly and a pivotable hinge barrel. The hinge barrel is pivotable about a pivot axis in relation to the connection plate among (a) a deployed position in which the hinge barrel is held relative to the connection plate in positive, locking retention; (b) a stowed position in which the hinge barrel is held relative to the connection plate in positive, locking retention; and (c) an intermediate position between the deployed and stowed positions, wherein the hinge barrel is held relative to the connection plate by a threshold retentive force and wherein displacement of the hinge barrel from the intermediate position relative to the connection plate requires application of an actuating force which exceeds the threshold retentive force.

In a more limited aspect, the helmet mount apparatus is provided in combination with the viewing device.

Various advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of a helmet mount apparatus according to an exemplary embodiment of the present invention attached to a helmet, wherein the helmet mount apparatus is in the deployed position.

FIGS. 2-4 are enlarged, fragmentary side views of the helmet and helmet mount apparatus appearing in FIG. 1, with the helmet mount apparatus in the deployed position, intermediate, and stowed positions, respectively.

FIG. 5 is an isometric view of the helmet mount apparatus appearing in FIG. 1 taken generally from the front and right side.

FIG. 6 is a partially exploded isometric view of the helmet mount apparatus appearing in FIG. 5.

FIG. 7 is an enlarged isometric view of the pivot assembly.

FIG. 8 is an exploded isometric view of the pivot assembly appearing in FIG. 7.

FIG. 9 is a front view of the pivot assembly appearing in FIG. 7.

FIG. 10 is a side cross-sectional view taken along the lines 10--10 appearing in FIG. 9.

FIG. 11 is an isometric view of the pivot assembly cylinder and tilt adjustment subassembly taken generally from the top and right side.

FIGS. 12 and 13 are a schematic view of two exemplary shaped openings in the cylindrical housing of the hinge barrel member.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected, whether the components are attached, joined, manufactured separately, or integrated as a single coherent unit. Such terms encompass configurations where components are formed separately and subsequently connected as well as configurations where components are integrally formed or exist as a monolithic structure without distinct connecting interfaces.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

In embodiments, a helmet mount apparatus for mounting an associated viewing device on a helmet includes a first pivoting segment for attachment to the helmet and a second pivoting segment for attachment to the associated viewing device. The second pivoting segment is pivotable relative to the first pivoting segment for selectively supporting the associated viewing device in a first, operational or deployed position before the eyes of a user donning the helmet and a second, stowed position above a line of sight of a viewer donning the helmet. A locking mechanism includes an actuator manually depressible by the user for pivoting the second pivoting segment relative to the first pivoting segment between the first position and the second position. A force to overcome mechanism is configured to secure the second pivoting segment relative to the first pivoting segment at a third, intermediate position which is intermediate the first and second positions, wherein the second pivoting segment is configured to move relative to the first pivoting segment from the third position to the first position upon manual application of force in a first rotational direction and wherein the second pivoting segment is configured to move relative to the first pivoting segment from the third position to the second position upon manual application of force in a second rotational direction which is opposite the first rotational direction.

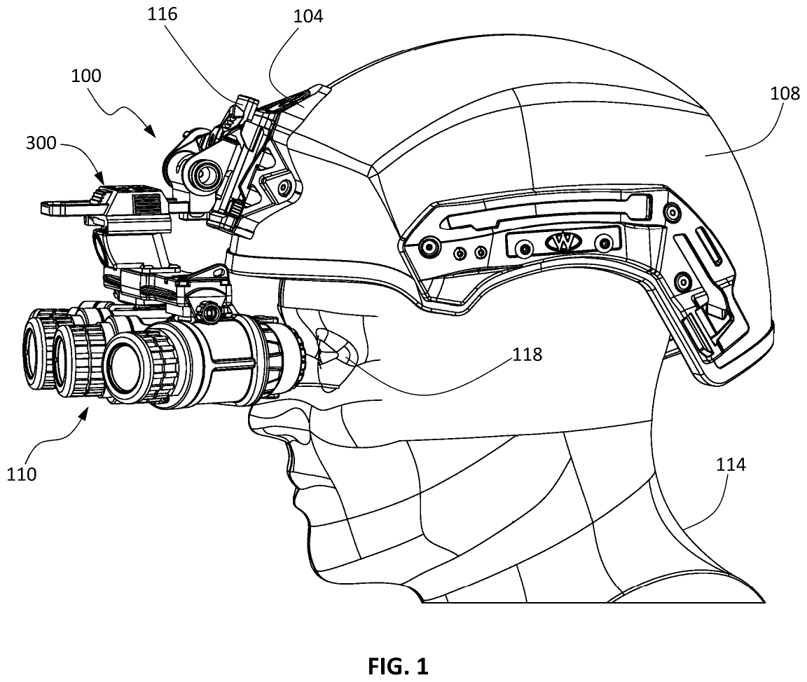

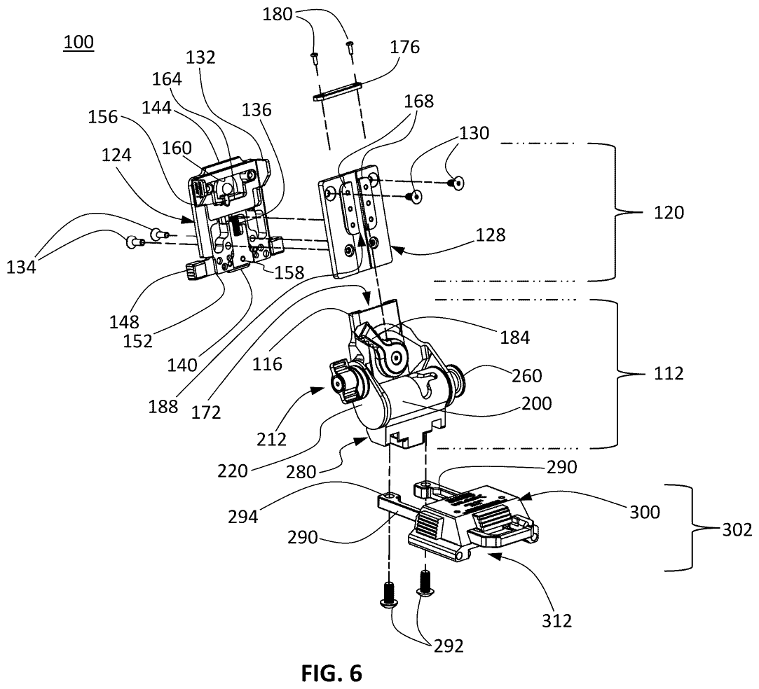

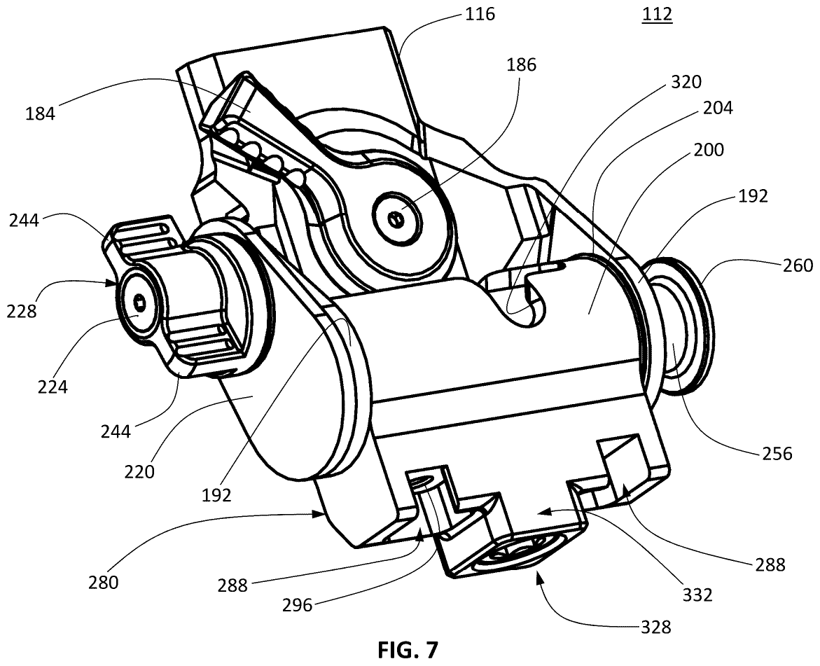

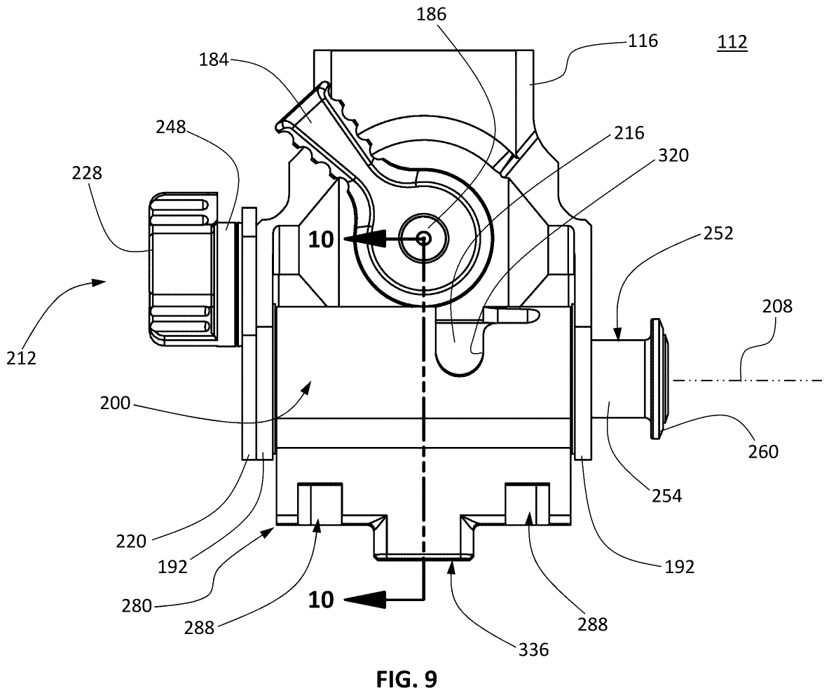

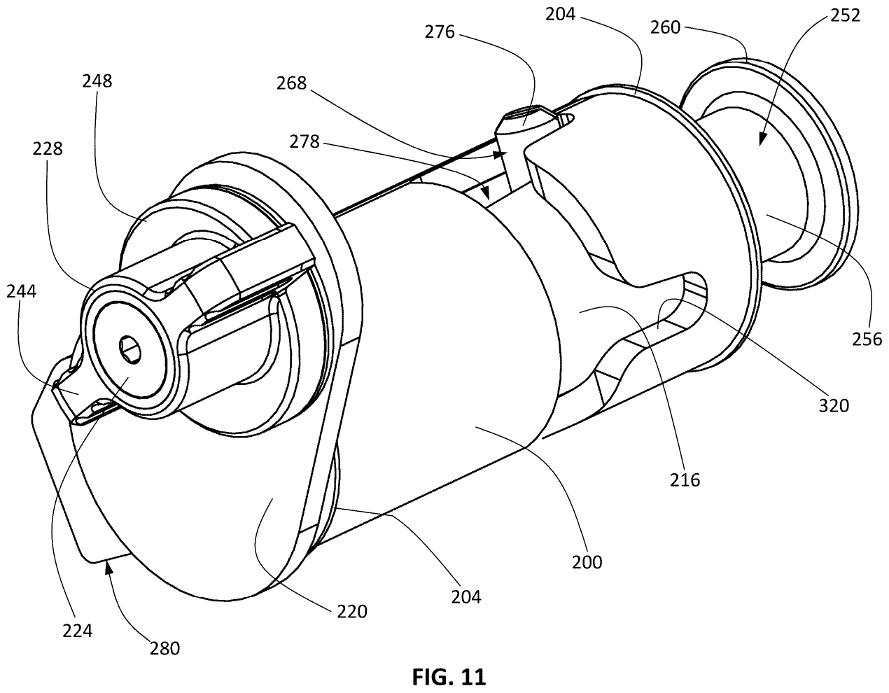

Referring now to the drawings FIGS. 1-13, wherein like reference numerals refer to like or analogous components throughout the several views, there appears an exemplary embodiment helmet mount apparatus 100 of the present disclosure. The helmet mount apparatus 100 is releasably attached to a front shroud 104 which, in turn is attached to a front portion of a helmet 108. In embodiments, the front shroud is a Wilcox L4 shroud available from Wilcox Industries Corp. of Newington, NH. Other shrouds 104 are also contemplated, including three-hole shrouds, single-hole shrouds, and others.

In embodiments, the helmet 108 is an Advanced Combat Helmet (ACH), Enhanced Combat Helmet (ECH), Modular Integrated Communications Helmet (MICH), Ballistic Combat Helmet (BCH), among others. A viewing device 110, in turn, is attached to the helmet mount apparatus 100 and supported by the helmet mount apparatus 100 in front of the eye(s) 118 of a user 114. In the illustrated embodiment, the viewing device is a panoramic night vision binocular device such as a Ground Panoramic Night Vision Goggle (GPNVG) available from L3Harris Technologies, Inc. It will be recognized that other viewing devices can be employed, such as monocular and binocular night vision devices, enhanced night vision devices, other monocular and binocular optical and opto-electronic devices, cameras, displays including head up displays and virtual or augmented reality displays, and the like.

The helmet mount apparatus 100 includes a pivot assembly 112. The pivot assembly 112 includes a connection plate 116 which is slidably coupled to a helmet interface assembly 120. The helmet interface assembly 120 includes a rear interface plate 124 and a front interface plate 128. The helmet interface assembly 120 defines a latching assembly that that engages with a complementary bracket or shroud on the front of the helmet and facilitates secures attachment and easy detachment. The rear interface plate 124 and a front interface plate 128 are secured via threaded fasteners 130 and 134. In the depicted embodiment, the helmet interface assembly 120 includes a breakaway actuator 132 movable in the transverse direction between a breakaway position and a non-breakaway position. When the breakaway actuator 132 is in the non-breakaway position, the helmet mount apparatus 100 will be securely locked into the shroud 104. When the breakaway actuator 132 is in the breakaway position, the helmet mount apparatus 100 will separate from the shroud 104 upon application of a sufficient force.

The rear interface plate 124 receives a spring or like tension member 136, which bears against a movable, locking tongue member 140 disposed at a lower end of the rear interface plate 124. The locking tongue 140 engages a complementary lower transverse groove or lip (not shown) formed in the shroud 104. A fixed protrusion or tongue 144 extends from an upper end of the rear interface plate 124. The fixed tongue 144 engages a complementary transverse upper groove or lip (not shown) formed in the shroud 104.

An actuator bar 148 is received within a transverse channel 152 and is transversely slidable therein. The actuator bar 148 engages the locking tongue member 140 and is slidable between a locked position and a release position. Movement of the actuator bar 148 to the release position is translated to upward vertical movement of the locking tongue member 140, e.g., by means of a mechanical linkage such as pin 158 riding in an angled clongate slot (not shown) in the actuator bar 148, to move the tongue member 140 upward against the urging of the spring 136. Movement of the actuator bar 148 to the locked position is translated to downward vertical movement of the locking tongue member 140.

In operation, to secure the helmet mount apparatus 100 to the shroud 104, the fixed tongue 144 is inserted into the upper slot on the shroud. The user also squeezes the actuator bar 148 against the urging of the spring 136 which retracts the lower movable tongue 140. The assembly 120 is then pressed into place on the shroud 104 and the actuator bar 148 is released, wherein the locking tongue 140 moves downward at the urging of the spring 136 to the engaged position with the lower groove or lip.

In operation, to select the non-breakaway configuration the breakaway actuator 132 is moved to the non-breakaway position. A tooth 156 is coupled to the locking tongue member 140 and rides along a profiled edge 164 of a slot or opening 160 in the breakaway actuator 132 to adjust a vertical position of the tongue 140. In the non-breakaway position, the tongue 140 is fully engaged and locked into with the lower slot on the shroud 104.

In operation, to select the breakaway configuration the breakaway actuator 132 is moved to the breakaway position. The tooth 156 coupled to the locking tongue member 140 rides along the profiled edge 164 of the slot or opening 160 in the breakaway actuator 132 to adjust the vertical position of the tongue 140. In the breakaway position, the tongue 140 is slightly elevated or withdrawn from the lower slot on the shroud 104 to allow the rear interface plate 124 to disengage from the shroud 104 upon application of a sufficient force.

In embodiments, the lower and front edge of the tongue member 140 and/or the upper and front edge of the lower slot in the shroud are chamfered, beveled, rounded, or the like. This provides a wedge action to move the tongue member 140 upward against the bias of the spring 136 when a separation force is applied to the helmet mount apparatus 100. When the breakaway actuator 132 is in the non-breakaway position the locking tooth is disposed at a sufficient depth within the lower shroud slot such that non-chamfered edges of the tongue member 140 and lower slot in the shroud are contacting such that wedge action does not occur when a separation force is applied to the helmet mount apparatus 100.

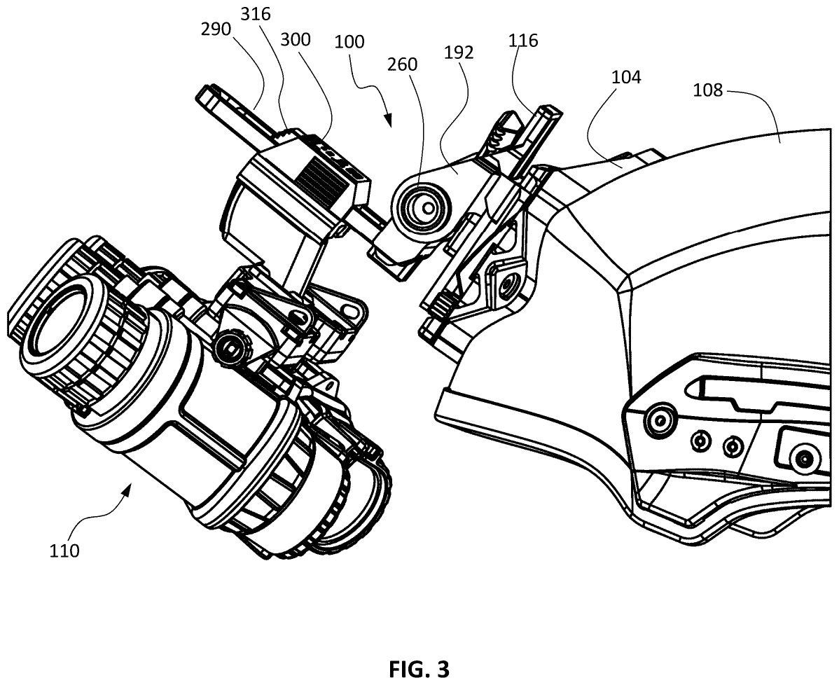

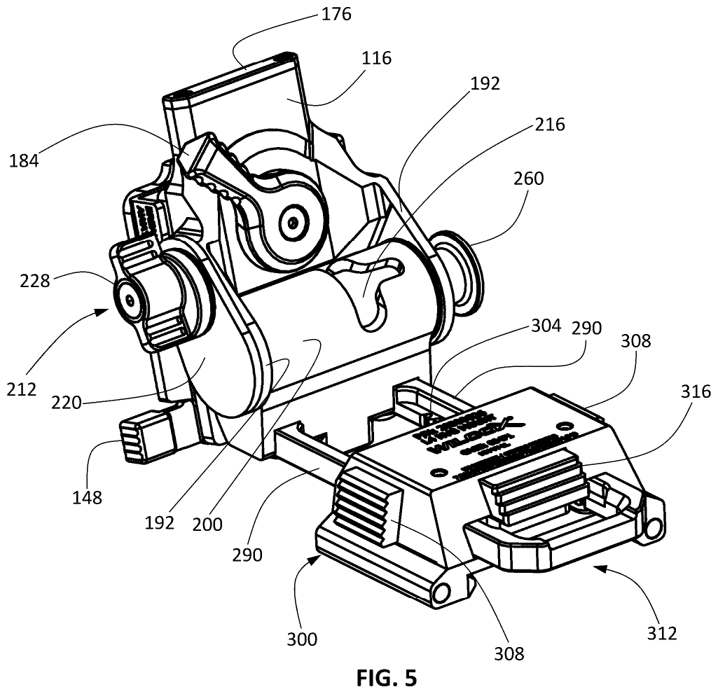

In embodiments, the helmet interface assembly 120 may be as described in commonly owned U.S. Pat. No. 8,739,313, the entire contents of which are incorporated herein. It will be recognized that other helmet interface assemblies are contemplated. For example, in certain embodiments, the helmet interface assembly 120 may be as shown in FIGS. 5A and 5B of the aforementioned U.S. Pat. No. 8,739,313 and described by way of reference thereto. In alternative embodiments, the helmet interface assembly 120 may be a non-breakaway helmet interface assembly, e.g., as shown in FIGS. 3A and 3B of the aforementioned U.S. Pat. No. 8,739,313 and described by way of reference thereto. The non-breakaway helmet interface assembly 120 may advantageously be selected in instances where it is desired to prevent inadvertent dislodging of an attached optical device from the helmet, e.g., where loss of the optical device is possible or where the operator may be subject to high acceleration or G forces.

The front interface plate 128 includes vertical adjustment rails 168 which are slidably received within a channel 172 formed on the rear side of the connection plate 116. The connection plate 116 slides in the vertical direction with respect to the front interface plate 128 to allow the user to align the device 110 with the user's eye(s). Cover plates 176 are secured with threaded fasteners 180 to close the upper and lower ends of the connection plate 116.

A vertical adjustment lever 184 on the front of the connection plate 116 is secured to a cam lock member (not shown) on the rear side of the connection plate 116 with a threaded fastener 186. The lever 184 is rotatable between a locked position and an unlocked position. The cam lock member is received within a channel or slot 188 defined between the vertical adjustment rails 168. When the lever 184 is pivoted to the unlocked position, the cam lock member is free to slide up and down within the channel 188 to provide a continuously adjustable vertical adjustment mechanism. When the assembly 112 is at a desired vertical position relative to the plate 128 (e.g., when the attached viewing device 110 is at the correct vertical position relative to the eyes of the user), the lever 184 is pivoted to the locked position. When the lever 184 is turned to the locked position, the cam lock member interacts with the locking rails 168 on the plate 128 to secure the vertical adjustment plate 116 in the desired position. In certain embodiments, the cam lock mechanism may be as described in the aforementioned U.S. Pat. No. 8,739,313. Sliding movement of the connection plate 116 thereby enables adjustment of the vertical position of the viewing device 110 relative to a line of sight of the user 114.

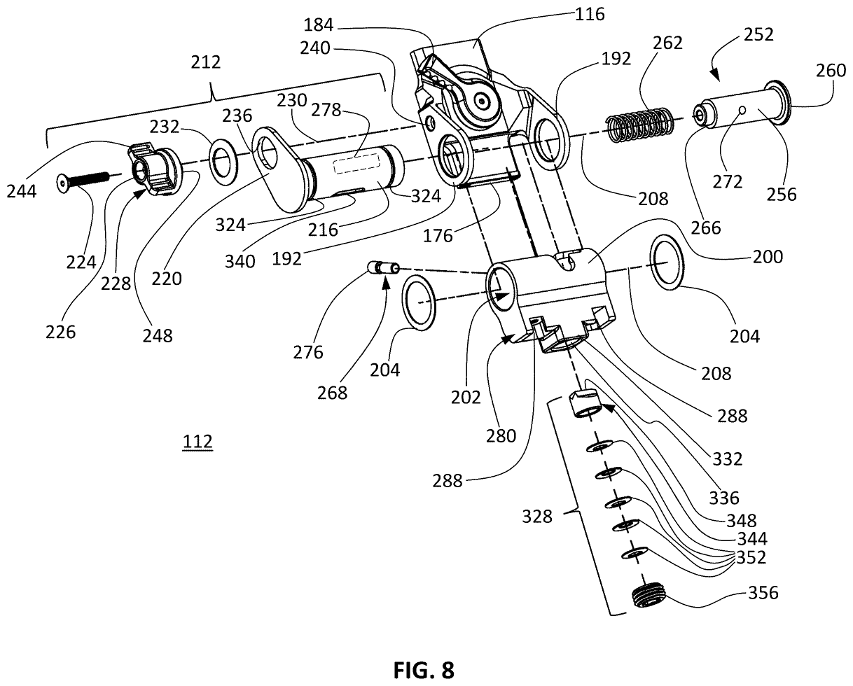

As best seen in FIG. 8, the pivot assembly 112 includes opposing first and second hinge knuckles 192 disposed on opposing transverse sides of the connection plate 116. A hinge barrel member 200 is disposed between the first and second hinge knuckles 192.

Washers or wear spacers 204 may be disposed in between the ends of the hinge barrel member 200 and the first and second hinge knuckles 192. The first and second hinge knuckles 192 and hinge barrel member 200 are aligned with a pivot axis 208. The hinge barrel 200 defines a cylindrical bore 202 along the pivot axis 208.

An angle or tilt adjustment knob sub-assembly 212 includes a generally cylindrical sleeve or bushing 216 and a tilt adjustment pivot arm 220. A threaded fastener 224 passes through a clearance opening 226 in a tilt adjustment knob 228, a washer 232, which may be a spring washer or conical disc spring, and an elongate/curvate opening 236 in the tilt adjustment pivot arm 220. The threaded fastener 224 engages a tapped opening 240 in the right hinge knuckle 192. The tilt adjustment knob 228 includes a user actuator feature such as wings 244 on the outward facing side and an eccentric cam member 248 on the opposite side. In embodiments, the cam member 248 includes a cylindrical boss which is off-center with respect to the clearance opening 226.

The cam member 248 runs within the opening 236 to allow rotation of the tilt adjustment pivot arm 220 in relation to the connection plate 116. In certain embodiments, the opening 236 is configured to allow a range of about 10 to 20 degrees of pivoting movement, e.g., about 10, 11, 12, 13, 14, 15, 16, 17, 18, 19, or 20 degrees, preferably about 15 degrees. Manually rotating the knob 228 allows adjustment of the viewing device 110 to a desired tilt angle about a tilt pivot axis 230, according to the user's eye position and a desired line of sight, whereby the tilt angle may then be secured in the desired position by tightening the knob 228. In embodiments, the tilt adjustment subassembly is a friction tensioning mechanism with a constant force applied against the Bellville disc spring. The screw 224 is torqued to a developed value and rotationally secured in place. As the cammed knob 228 is rotated, the off center position of the screw 224 in relation to the cam body 248 causes the tilt angle to change. The adjusted position is held in place by friction.

A pivot pin 252 includes a pivot shaft 256 received within the bushing 216 and a push button 260. A biasing spring 262 is received within the bushing 216 and is compressed and bears against a shoulder 266 of the shaft 256 to bias the pivot pin 252 outwardly. A positioning pin 268 is received within a bore 272 in the pivot rod shaft 256. The positioning pin 268 includes a protruding head 276. The positioning pin 268 passes through an elongate opening 278 (shown in hidden lines) disposed on the back of the bushing 216, wherein the clongate opening 278 limits the extent of transverse travel of the pivot pin 252. In embodiments, the clongate opening 278 may be tapered such that it narrows toward the left side and widens toward the right side. Such tapering provides a wedging action on the positioning pin 268 and provides case of operation during the pivoting operation.

The hinge barrel 200 is pivotable about the pivot axis 208 with respect to the protruding head 276 and the connection plate 116. A pivot arm 280 includes connection points 288 for receiving a pair of rails 290 extending in the horizontal position (when the helmet is worn by a user and the optical device is in the operation, i.e., flipped down, position). The connection points 288 may comprise keyed or geometrically shaped recesses complementary with the rail 290 proximal ends. Threaded fasteners 292 pass through clearance openings 294 in the rail 290 proximal ends and engage tapped openings 296 in the connection points 288.

A sliding carriage 300 and the rail member 290 cooperate to form a carriage assembly 302. The sliding carriage 300 is movable along the slide rails 290 to allow the user to horizontally position the viewing device 110 at a comfortable or desired focal distance from the eye(s) 118 of the operator 114. At least one of the slide rails 290 contain a series of locking teeth 304 along its length for engaging an internal locking member such as a toothed member, pin, or the like, to provide secure retention at a selected position. Release buttons 308, biased toward the locked position, may be manually depressed to disengage the locking members to allow sliding movement of the carriage 300 in the fore and aft direction until the viewing device 110 is positioned at a desired focal position in front of the user's eye(s) 118. The sliding carriage 300 also includes a mount receptacle 312 for receiving a mounting member, such as a dovetail mounting shoe or the like, on the viewing device 110.

The bushing 216 is received within the cylindrical bore 202 of the hinge barrel 200. A shaped opening 320 is formed in the hinge barrel 200. The protruding head 276 of the positioning pin 268 rides in the shaped opening 320 and constrains pivoting movement of the hinge barrel 200 in relation to the helmet interface assembly 120. Optional elastomeric rings (e.g., O-rings) (not shown) may be disposed within annular channels 324 on the bushing 216 to provide a desired degree of friction between the hinge barrel 200 and the bushing 216.

A locking detent assembly 328 is carried within a detent interface 332 on the pivot arm 280. The detent interface 332 defines a detent bore 336 which is generally perpendicular or radially extending with respect to the pivot axis 208 and extends through the detent interface 332 to the bore 202 of the hinge barrel 200. The perpendicular bore 336 is axially aligned with a detent groove 340 on the outward facing surface of the bushing 216.

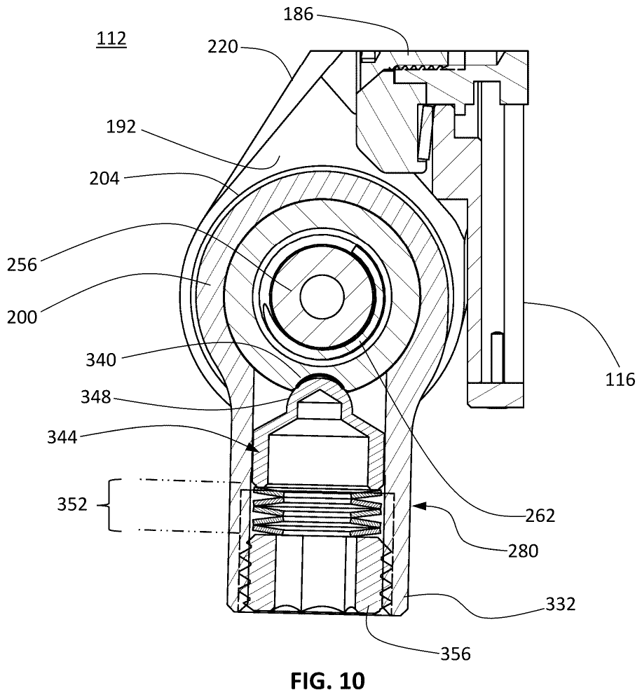

The locking detent assembly 328 includes a detent member 344, e.g., a cylindrical detent member, having a tongue 348 disposed on an upper surface. The detent member 344 is received within the bore 336. The tongue 348 is complementary with the detent groove 340. The tongue 348 and/or the detent groove 340 may have rounded or chamfered edges to facilitate movement of the detent tongue 348 into and out of engagement with the detent groove 340. In certain embodiments, as best seen in FIG. 10, the channel 340 has a first curved radius and the detent tongue 348 has a second radius, wherein the radius of the detent tongue 348 is slightly larger than the radius of the channels 340.

One or more detent spring members 352 are captured within the bore 336 between detent member 344 and a threaded set screw 356. The threaded set screw 356 engages internal threads within the end of the bore 336. In the illustrated embodiment, the spring members 352 comprise a stack of Belleville washers. The spring members 352 urge the detent member 344 toward the bushing 216. The set screw 356 may be rotated to selectively advance or retract the set screw 356 within the bore 336 to adjust the force with which the detent member 344 bears against the bushing 216.

In certain embodiments, a soft-tipped set screw (not shown) in the hinge barrel 200 is provided to eliminate looseness or rattle between the hinge barrel 200 and the bushing 216, e.g., as may occur over time through wear. However, in certain embodiments, the hinge barrel 200 does not include a soft-tipped set screw. Since the detent member 344 bears resiliently against the bushing 216, there is not a need to utilize a soft-tipped set screw for the purpose of eliminating looseness or rattle between the hinge barrel 200 and the bushing 216. It will be recognized, however, that in certain embodiments, a soft tipped set screw in the hinge barrel 200 and bearing against the bushing 216 may be desired, e.g., to provide a further adjustment of the friction or resistance to rotation between the hinge barrel 200 and the bushing 216.

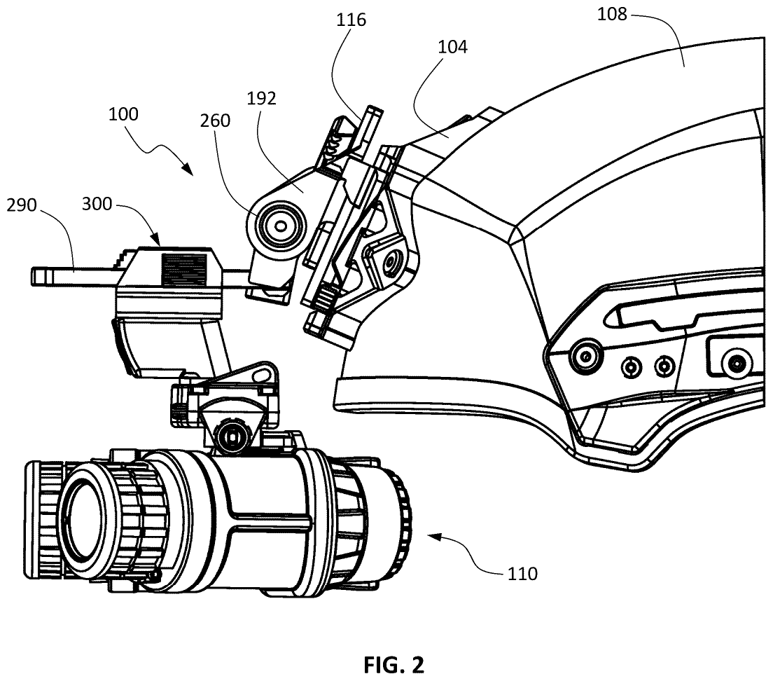

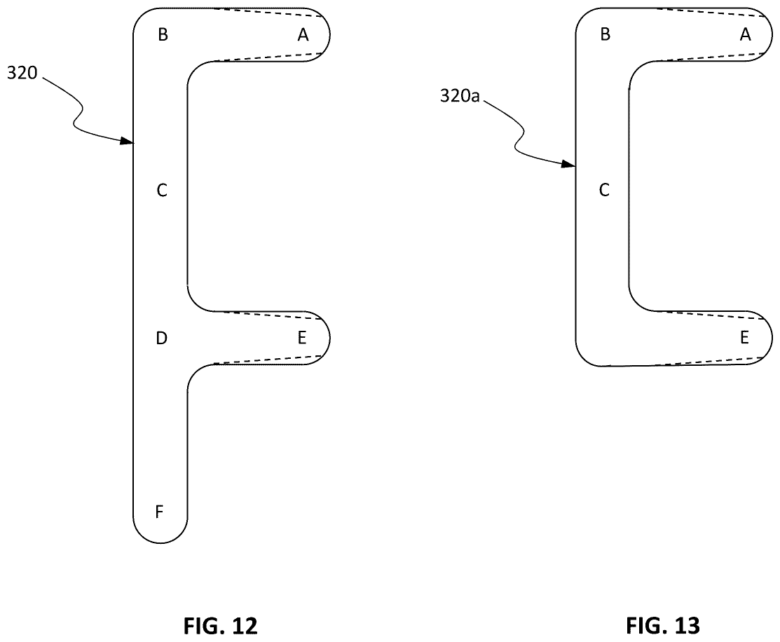

Referring now to FIG. 12, the layout of an exemplary embodiment of the pin guide opening 320 is illustrated, wherein the pin guide opening 320 has a generally F-shaped configuration, having designated positions identified as positions A-F. When the positioning pin 268 is in position A, the hinge barrel 200 is in the deployed position as shown in FIGS. 1 and 2, i.e., wherein the slide carriage rails 290 are substantially horizontal and the device 110 is in front of the eye(s) of the user. When the positioning pin 268 is in position A, the pivot sub-assembly acts as a locking pivot and requires that the button 260 to be manually depressed to rotate the hinge barrel 200 to another rotational position. In position A, the spring 262 bears against the pivot rod 256 to retain the positioning pin 268 in position. In operation, position A is advantageously used in dark or low light conditions.

When it is desired to pivot the pivot arm 280 upward to move an attached device 110 above the user's line of sight, the button 260 is manually depressed against the urging of the biasing spring 262 to cause the positioning pin 268 to move to position B. The viewing device is then manually pushed upward, wherein the hinge barrel 200 pivots until the positioning pin 268 reaches position C. Since the bushing 216 is prevented from rotating by the positioning pin 268, the bushing remains in a fixed position as the hinge barrel 200 is rotated. In operation, position C is advantageously used during mixed lighting conditions when constant night vision deployment is not desirable.

When the hinge barrel 200 is rotated such that the positioning pin 268 reaches the position C, the detent tongue 348 is in angular alignment with the detent groove 340 on the bushing 216 and the spring members 352 urge the detent tongue 348 into the detent groove 340. The detent groove 340 has an angular position on the bushing 216 such that when the positioning pin 268 reaches the position C, the hinge barrel 200 is pivoted partially upward with respect to the deployed position, i.e., so that the slide carriage rails 290 are angled upward relative to horizontal as illustrated in FIG. 3. In embodiments, the upward angle of the slide carriage rails 290 when the detent tongue 348 engages the detent groove 340 is sufficient to move an attached device 110 above a line of sight of the user.

In embodiments the rotational angle of the hinge barrel 200 about the pivot axis 208 between the deployed position and the intermediate position wherein the detent tongue 348 engages the detent groove 340 is in the range of from about 7 to about 30 degrees (e.g., 7, 8, 9, 10, 11, 12, 13, 14, 15, 16, 17, 18, 19, 20, 21, 22, 23, 24, 25, 26, 27, 28, 29, or 30 degrees. In embodiments, such angle is in the range of from about 10 to about 25 degrees. In embodiments, such rotational angle is in the range of from about 15 to about 20 degrees. In embodiments, such rotational angle is about 20 degrees.

When the positioning pin 268 is in the position C and the detent tongue 348 engages the detent groove 340, the pivot sub-assembly 112 acts as a force to overcome type mechanism, wherein the user has the option of manually pushing upward to cause the positioning pin 268 to move back to position B or manually pulling downward to cause the positioning pin 268 to move to position D. If the user pushes upward with sufficient force to overcome the force of the locking detent assembly 328, the positioning pin 268 moves back to position B, whereupon the biasing spring 262 urges the pivot pin 252 outwardly and the positioning pin 268 automatically returns to position A.

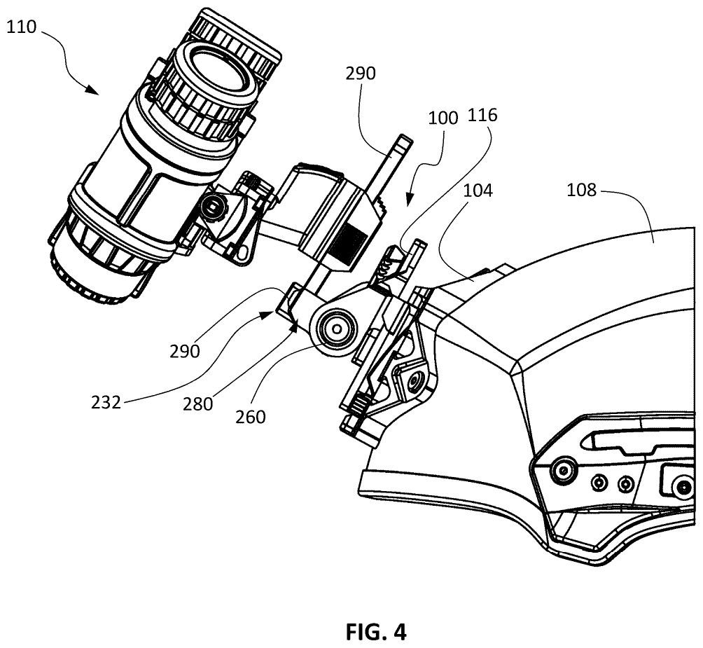

If the user pushes downward with sufficient force to overcome the force of the locking detent assembly 328, the positioning pin 268 moves to position D, whereupon the biasing spring 262 urges the pivot pin 252 outwardly and the positioning pin 268 automatically moves to position E. When the positioning pin 268 is in position E, the hinge barrel 200 is in the stowed position as shown in FIG. 4. When the positioning pin 268 is in position E, the pivot assembly 112 again acts as a locking pivot and requires the button 260 to be manually depressed against the bias of the spring 262 in order to further change the pivot position. When the positioning pin 268 is moved back to position D via the push button 260, the user has the option of pulling downward to cause the positioning pin 268 to move back to position C or pushing upward to cause the positioning pin 268 to move to position F. If the user pulls downward to cause the positioning pin 268 to move back to position C, further pivoting is as described above. If the positioning pin 268 is in position D and the user pushes upward to cause the positioning pin 268 to move to position F, the attached viewing device 110 will be moved upward beyond the stowed position as shown in FIG. 4, i.e., further toward the helmet.

In certain embodiments, the hinge assembly 112 does not include an integrated retention mechanism for automatically securing the hinge assembly in position with the positioning pin at position F. Rather, when the user elects to manually pivot the viewing device upward, so that the positioning pin 268 is in position F, the user has the option to fasten the viewing device in this position with a bungee, strap, or other fastener which is external to the pivot assembly 112. To change the position when the positioning pin 268 is in position F, the user may disengage the bungee, strap, or other fastener such that the unit will pivot downward, e.g., under the influence of gravity. As the unit is pivoting downward, when the positioning pin 268 moves back to position D, the biasing spring 262 urges the pivot pin 252 outwardly and the positioning pin 268 automatically returns to position E. Any further movements can then be performed as described above.

In certain embodiments, the segment A-B of the shaped openings 320 (FIGS. 12) and 320a (FIG. 13) may be tapered such that it narrows toward position A and widens toward position B, and wherein the segment D-E narrows toward position E and widens toward position D. Such tapering provides a wedging action on the positioning pin 268 and provides case of operation during the pivoting operation, e.g., by providing additional clearance when the positioning pin 268 is in the segment B-F (see FIG. 12) or B-D (see FIG. 13).

Referring now to FIG. 13, there is shown an alternative shaped opening 320a which is as described above by way of reference to the shaped opening 320 appearing in FIG. 12 except that the position F is eliminated.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A pivot assembly for pivoting a viewing device in relation to a helmet, the pivot assembly comprising:
a connection plate configured to be coupled to a helmet interface assembly;
a hinge barrel pivotable about a pivot axis in relation to said connection plate among (a) a deployed position in which said hinge barrel is held relative to said connection plate in positive, locking retention; (b) a stowed position in which said hinge barrel is held relative to said connection plate in positive, locking retention; and (c) an intermediate position between said deployed and stowed positions, wherein said hinge barrel is held relative to said connection plate by a threshold retentive force and wherein displacement of the hinge barrel from the intermediate position relative to the connection plate requires application of an actuating force which exceeds the threshold retentive force.

2. The pivot assembly of claim 1, further comprising:
first and second hinge knuckles disposed on opposing transverse sides of said connection plate;
said hinge barrel disposed between said first and second hinge knuckles, said hinge barrel defining a cylindrical bore along said pivot axis;
a first aperture formed in a sidewall of the hinge barrel which provides access to the cylindrical bore;
a pivot arm coupled to the hinge barrel and configured to rotate with the hinge barrel about the pivot axis;
a detent bore extending radially through the pivot arm and communicating with said cylindrical bore;
a bushing comprising a cylindrical body and an axially-extending bore, said bushing disposed within the cylindrical bore of the hinge barrel, said bushing comprising a recess formed on the cylindrical body and a second aperture formed radially from an outer surface of the cylindrical body to the axially-extending bore, wherein the second aperture is elongated in the axial direction and has a preselected axial extent;
a detent assembly received within the detent bore, said detent assembly comprising a resilient protrusion, said resilient protrusion complementary with said recess;
a pivot rod telescopically received within said axially-extending bore;
a biasing spring disposed within said axially-extending bore and configured to urge said pivot rod in an outward direction along said pivot axis; and
a positioning pin secured to said pivot rod and passing through said second aperture and extending at least partially into said first aperture, wherein the second aperture is configured to limit telescoping movement between the pivot rod and the bushing to said axial extent and wherein the first aperture is configured to constrain a range of rotational movement of the hinge barrel in relation to the bushing when the hinge barrel is pivoted between the deployed, intermediate, and stowed positions.

3. The pivot assembly of claim 2, wherein the detent assembly comprises:
a detent member received within said detent bore, said detent member having a tongue disposed on an upper surface;
a threaded set screw that engages internal threads within said detent bore; and
at least one detent spring member captured within said detent bore between said detent member and said threaded set screw, such that said at least one spring member urges said detent member away from said threaded set screw and toward said bushing.

4. The pivot assembly of claim 2, wherein said pivot rod comprises a shaft portion received within the axially-extending bore and a manually actuatable push button.

5. The pivot assembly of claim 2, wherein the first aperture comprises:
a first segment which extends parallel to the pivot axis and having a first end and a second end opposite the first end;
a second segment which extends parallel to the pivot axis and having a first end and a second end opposite the first end, the second segment axially aligned with the first segment and angularly spaced apart from the first segment; and
a third segment which extends transversely with respect to the pivot axis, the third segment intersecting with the second end of the first segment and the second end of the second segment.

6. The pivot assembly of claim 5, further comprising:
said biasing spring configured to urge the positioning pin toward the first end of the first segment when the hinge barrel is pivoted to the deployed position;
said biasing spring configured to urge the positioning pin toward the first end of the second segment when the hinge barrel is pivoted to the stowed position.

7. The pivot assembly of claim 6, further comprising:
said resilient protrusion configured to engage said recess when the hinge barrel is manually pivoted to the intermediate position, wherein the positioning pin is disposed within said third segment at a position intermediate the second end of the first segment and the second end of the second segment.

8. The pivot assembly of claim 6, wherein said first segment is tapered to narrow toward the first end of the first segment and the second segment is tapered to narrow toward the first end of the second segment.

9. The pivot assembly of claim 1, further comprising:
a carriage assembly coupled to the hinge barrel, the carriage assembly configured to interface with the viewing device.

10. The pivot assembly of claim 9, wherein the carriage assembly comprises one or more rail members secured to the hinge barrel and a sliding carriage configured to be selectively positioned on said one or more rail members for adjusting a distance between the viewing device and an eye of a user.

11. The pivot assembly of claim 1, further comprising:
a helmet interface assembly coupled to the connection plate, the helmet interface assembly configured to secure the pivot assembly to a helmet.

12. The pivot assembly of claim 1, the helmet interface assembly comprising:
a front interface plate disposed coupled to said connection plate, said front interface plate comprising vertical adjustment rails defining a channel;
a cam lock member disposed on a rear, helmet-facing side of said connection plate, said cam lock member received within said channel;
a vertical adjustment lever disposed on a forward facing side of said connection plate, the vertical adjustment lever secured to said cam lock member and rotatable between a locked position and an unlocked position;
said cam lock member configured to slide within said channel when the lever is in the unlocked position; and
said cam lock member configured to be held in place within said channel when the lever is in the locked position.

13. The pivot assembly of claim 1, wherein the helmet interface assembly includes a breakaway mechanism configurable between a non-breakaway configuration and a breakaway configuration, wherein said helmet interface assembly is configured to securely lock to a mounting fixture disposed on the helmet when the breakaway mechanism is in the non-breakaway configuration and wherein the helmet interface assembly is configured to separate from the mounting fixture upon application of a predetermined force when the breakaway mechanism is in the breakaway configuration.

14. The pivot assembly of claim 13, wherein the mounting fixture is selected from the group consisting of a three-hole shroud and a one hole shroud.

15. The pivot assembly of claim 1, further comprising a tilt adjustment assembly for adjusting a tilt position of the viewing device relative to an eye of a user.

16. A helmet mount apparatus for a viewing device, the helmet mount apparatus comprising:
a helmet interface assembly configured to engage with a helmet;
a pivot assembly of coupled to the helmet interface assembly, the pivot assembly comprising:
a connection plate configured to be coupled to a helmet interface assembly; and
a hinge barrel pivotable about a pivot axis in relation to said connection plate among (a) a deployed position in which said hinge barrel is held relative to said connection plate in positive, locking retention; (b) a stowed position in which said hinge barrel is held relative to said connection plate in positive, locking retention; and (c) an intermediate position between said deployed and stowed positions, wherein said hinge barrel is held relative to said connection plate by a threshold retentive force and wherein displacement of the hinge barrel from the intermediate position relative to the connection plate requires application of an actuating force which exceeds the threshold retentive force; and
carriage assembly coupled to the pivot assembly, the carriage assembly configured to engage with the viewing device.

17. The helmet mount apparatus of claim 16, in combination with the viewing device.
